(19) United States
(12) Patent Application Publication
(10) Pub. No.: US 2024/0243806 A1
(43) Pub. Date: Jul. 18, 2024

(54) System and Method for Satellite Communication Supporting Reduced Latency

(71) Applicant: 6Harmonics, Ottawa (CA)

(72) Inventor: Shinquan Wu, Ottawa (CA)

(21) Appl. No.: 18/411,094

(22) Filed: Jan. 12, 2024

Related U.S. Application Data
(60) Provisional application No. 63/479,658, filed on Jan. 12, 2023.

(51) Int. Cl. H04B 7/185; H04W 28/12

(52) U.S. Cl. CPC H04B 7/18513; H04W 28/12

(57) ABSTRACT

A system has a network communication interface for initiating a communication link between a first system and a second other system. The communication link includes an uplink from the first system to the second other system and a downlink from the second other system to the first system. The communication interface transmits signals from the first system via the uplink consisting of a terrestrial wireless communication link absent satellite communications therein to the second other system. The communication interface transmits signals from the second other system via the downlink consisting of a satellite-based communication link to the first system.

### FIELD OF THE INVENTION

The invention relates to wireless networking and more particularly to satellite networking supporting reduced latency.

### BACKGROUND

Satellite communication systems consist of a first ground station for transmitting and receiving wireless communication signals from one or more satellites orbiting the Earth, and a second ground station for transmitting and receiving wireless communication signals from one or more satellites orbiting the Earth.

The first ground station connects one connection to the Internet and via another connection transmits signals to the satellite at frequency f1 (uplink) and receives the desired signal from satellite at frequency f2 (downlink).

A satellite in a designated orbit (LEO, GEO or MEO) has a communications system, which includes the antennas and transponders that receive and retransmit signals, the power system, which includes the solar panels that provide power, and the propulsion system.

CPE (customer premise equipment) connects user's devices such as laptops, phones, TVs and other smart devices using wired and/or wireless (Wi-Fi) methods, and transmits the desired signal to the satellite at frequency f3 (uplink) and receives the desired signal from satellite at frequency f4 (downlink).

In single satellite systems, the satellite is geostationary, orbiting above the Earth in a same location relative to a surface of the Earth. Each of the first and second ground stations has an antenna directed at the satellite. A signal is transmitted from the first ground station to the satellite and the satellite then directs a signal back toward the Earth to be received by the second ground station.

Unfortunately, geostationary satellites orbit at 35,786 km producing a significant signal latency caused by transmitting a wireless electromagnetic signal through a path length of approximately 71,572 km. The travel time for light over this distance is nearly 0.25 seconds. In contrast, the circumference of the Earth is only slightly greater than 35,786 km allowing terrestrial wireless signals to have distances of signal propagation that are much shorter, typically having a maximum propagation distance of approximately a quarter that of a satellite and a minimum propagation distance on the order of hundreds of kilometers.

Low orbit satellites, such as Starlink® orbit at 550 km, introducing much less signal latency, and are therefore considered superior for low-latency application. However, in practice, the process of communicating through satellites typically produces unacceptable latencies.

Due to the long distance from satellite to earth and necessary feedback loops, the round-trip delay is usually about 300 ms for geostationary and 45 ms for LEO such as Starlink®.

In many instances it would be advantageous to reduce bidirectional signal latency such as critical communications, smart hydro, gaming etc.

### SUMMARY

As used herein, the terms “first” and “second” and “third” provide labels and do not denote ordering or a specific element other than to distinguish one element, step, or component from another. Thus, a first part and a second other part refers to two different parts and does not infer that either is used or installed first relative to another in time or in space. Further, the label “first,” “second” or “third” are not intended to modify their respective noun/verb but instead to differentiate same.

In accordance with an embodiment there is provided a method comprising: initiating a communication link between a first system and a second other system, the communication link including an uplink from the first system to the second other system and downlink from the second other system to the first system; transmitting signals from the first system via the uplink consisting of a terrestrial wireless communication link absent satellite communications therein to the second other system; and transmitting signals from the second other system via the downlink consisting of a satellite-based communication link to the first system.

In some embodiments the downlink is transmitted via a communication link including portions that are terrestrial.

In some embodiments wherein the uplink is transmitted via terrestrial wireless communication network absent a satellite link forming part of the communication path.

In some embodiments the uplink includes a link having low data throughput communication relative to the satellite communication data throughput.

In some embodiments for some first signals from the first system the uplink is via a terrestrial wireless network and for other second signals from the first system the uplink is via a satellite communication network.

In some embodiments the some first signals are determined based on data throughput utilisation of the terrestrial wireless network.

In some embodiments the some first signals are determined based on a type, priority and purpose of the some first signals.

In some embodiments the some first signals are determined based on a latency requirement for the some first signals.

In some embodiments all signals from the first system the uplink is via a terrestrial wireless network and all signals to the first system are via a satellite communication network.

In accordance with an embodiment there is provided a method comprising: initiating a communication link between a first customer system and a second other system; determining a data throughput requirement for communicating from the first customer system to the second other system, available data throughput on each of a first terrestrial wireless communication link and a satellite communication link in each of an uplink and downlink directions; communicating with the provider via a terrestrial wireless communication link absent satellite communications therein in either an uplink direction or a downlink direction; and communicating with the provider via a satellite communication link in another of the uplink direction or the downlink direction.

In accordance with an embodiment there is provided a method comprising: initiating a communication link between a first customer system and a second other system; determining a data throughput requirement for communicating to the second other system; when the data throughput requirement is below a first threshold, communicating to the second other system via a terrestrial wireless communication link absent satellite communications therein; and when the data throughput requirement is above a first threshold, communicating to the second other system via a satellite-based communication link, a same first customer communicating with the second other system through each of the terrestrial and the satellite communication link at different times absent changing the first customer system setup parameters.

In accordance with an embodiment there is provided a method comprising: initiating a communication link between a first customer system and a second other system; determining a data throughput requirement for communicating from the second other system; when the data throughput requirement is below a first threshold, communicating from the second other system via a terrestrial wireless communication link absent satellite communications therein; and when the data throughput requirement is above a first threshold, communicating to the second other system via a satellite-based communication link, a same first customer system communicating with one of same and different second other systems through each of the terrestrial wireless and the satellite communication link at different times without changing the first customer system setup parameters.

In some embodiments determining communication requirements for the second other system comprises retrieving requirements from a data store.

In some embodiments setting up communication paths is performed in accordance with the retrieved communication requirements.

In accordance with an embodiment there is provided a method comprising: initiating a communication link between a first customer system and a second other system; determining a data throughput requirement for communicating from the second other system; when the data throughput requirement is below a first threshold, communicating from the second other system via a terrestrial wireless communication link absent satellite communications therein; and when the data throughput requirement is above a first threshold, communicating to the second other system via a satellite-based communication link, a same first customer system communicating with one of same and different second other systems through each of the terrestrial wireless and the satellite communication link at different times without changing the first customer system setup parameters.

In some embodiments determining communication requirements for the second other system comprises acquire requirements from a geolocation database.

In some embodiments communication paths are set up in accordance with the retrieved communication requirements.

In accordance with an embodiment there is provided a method comprising: providing a list of communications and their communication requirements; initiating a communication link between a first customer system and a second other system having at least an entry in the list; determining communication requirements for the second other system based on the at least an entry; setting up communication paths in accordance with the listed requirements, the uplink data path and the downlink data path different one from the other.

In some embodiments the uplink data path is via a terrestrial wireless communication network and the downlink data path is via a satellite communication network.

In some embodiments the uplink system-information-only data path is via a terrestrial wireless communication network and the uplink traffic data path is via a satellite communication network.

In some embodiments the downlink data path is via a terrestrial wireless communication network and the uplink data path is via a satellite communication network.

In accordance with an embodiment there is provided a system comprising a downlink communication link for receiving communication signals from a satellite and an uplink communication link for transmitting signals via a terrestrial wireless communication network absent a satellite communication link.

In some embodiments the downlink communication link is absent a transmitter for transmitting a signal to a satellite.

In some embodiments the system is absent a transmitter for transmitting a signal to a satellite via a same antenna as receives the downlink communication link.

In accordance with an embodiment there is provided a system comprising: an uplink transmitter; a downlink receiver; and a local communication transceiver for transmitting signals to a local communications device and for receiving signals from a local communications device, the uplink transmitter configured to preferentially select a terrestrial wireless communication network for transmission of uplink signals and the downlink receiver configured to receive signals transmitted thereto from a satellite directly.

In some embodiments the local communication is via a frequency within the TVWS band.

Some embodiments further comprise a frame wherein the local communication

transceiver is physically affixed to the frame and wherein the downlink receiver is also physically affixed to the frame.

In some embodiments the local communication is physically coupled to the downlink receiver with a communication cable.

In accordance with an embodiment there is provided a system comprising: a downlink communication link for receiving communication signals from a satellite and an uplink communication link for transmitting signals via a terrestrial wireless communication network.

In accordance with an embodiment there is provided a system comprising: a local communication device comprising: an uplink wireless transmitter for transmitting signals along a wireless terrestrial communication path; a downlink receiver for receiving satellite communication signals from a satellite in orbit; and a local communication transceiver for transmitting signals to the local communications device and for receiving signals from the local communications device.

In some embodiments the downlink communication link is absent a transmitter for transmitting a signal to a satellite.

In some embodiments the system is absent a transmitter for transmitting a signal to a satellite via a same antenna as receives the downlink communication link.

### DRAWINGS

Exemplary embodiments of the invention will now be described in conjunction with the following drawings, wherein similar reference numerals denote similar elements throughout the several views, in which:

FIG. 1a is a simplified diagram of a terrestrial wireless communication network;

FIG. 1b is a simplified communication diagram for nodes within a network of FIG. 1a;

FIG. 2a is a simplified diagram of a satellite-based communication network;

FIG. 2b is a simplified communication diagram for nodes within a network of FIG. 2a;

FIG. 3a is a simplified diagram of a hybrid communication network with a terrestrial wireless communication link and a satellite-based communication link; and

FIG. 4a is a simplified diagram of a hybrid communication network with a terrestrial wireless communication link for supporting uplink communications and a satellite-based communication link for supporting downlink communications;

FIG. 4b is a simplified communication diagram for nodes within a network of FIG. 4a;

FIG. 4c is a simplified communication diagram for nodes within a network of FIG. 4a;

FIG. 5 is a simplified diagram for nodes within a network;

FIG. 6 is a simplified diagram for nodes within a network wherein downlink portions are partially replaced with a terrestrial wireless TVWS wireless communication network;

FIG. 7 is a simplified diagram for nodes within a network supporting bidirectional communication via the terrestrial network and via the satellite network;

FIG. 8 is a simplified diagram for nodes within a network supporting bidirectional communication via the terrestrial network and via the satellite network selected in accordance with priority;

FIG. 9 is a simplified diagram for nodes within a TVWS communication backup network; and

FIG. 10 is a simplified diagram for nodes within a communication network supporting duplication of transmission to improve probability of signal reception.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

Geostationary (GEO) satellites are satellites orbiting the Earth at a distance of approximately 36,000 Km providing a position that remains approximately stationary above the Earth's surface. A geostationary Orbit above a specific geographic location should remain approximately above that location for a considerable contiguous length of time.

Communication path is a path within a network allowing for a communication to traverse one or more communication links between a first system and a second other system for propagating a signal or a portion of a signal between the first system and the second other system. When a communication path includes more than one communication link, the communication path also includes communication sub-paths, a single communication path formed of a plurality of communication subpaths and/or a plurality of communication links.

Terrestrial communication refers to communications either wireless, wired, fibre optic, or via another transmission medium to and from communication equipment on the Earth's surface via equipment that is Ground Based and absent a satellite communication link within a communication path.

Terrestrial wireless communication refers to communications to and from communication equipment on the Earth's surface via equipment that is Ground Based wherein at least one communication link is wireless and absent a satellite communication link within a communication path.

Latency is a measure of a delay between transmission and reception of a communication signal. In use, latency is often noticed as a delay that causes one to wait between speaking and hearing a response. For example, when communicating via geostationary satellite, there is often a delay measurable in seconds between finishing speaking and the beginning of another person's response.

Low orbit (LO) Satellites or Low Earth Orbit (LEO) satellites orbit the Earth at about 250 to 2000 Km of altitude. This is significantly closer than geostationary orbit satellites, but unfortunately means that the LO satellites are not positioned fixedly above a single point on the Earth.

Link is a data path from a first system to a second other system. The term link refers to the ability to communicate data between the first system and the second other system, whether directly or via a number of intermediate network nodes.

Uplink is a data path from a CPE to the terrestrial wide area network.

Downlink is a data path from the terrestrial wide area network to the CPE.

Satellite downlink is the data path from a satellite ground station to a CPE via a satellite relay.

Satellite uplink is the data path from a CPE to a satellite ground station via a satellite relay.

Round-Trip Delay is a measure of the cumulative effects of latency in both directions.

Satellite-based communication refers to communications to and from communication equipment wherein one or more links within a communication path include a satellite therein such that for at least one link a signal is transmitted from and/or received at a communication satellite.

TVWS (or TV white space, or television white space) is a portion of the wireless communication spectrum including parts of the VHF and UHF bands initially allocated for television broadcast transmission and spacing there between and now unused or regulatory permitted to use in some areas, some different TVWS frequency bands exist in some different geographic areas.

Referring to Figure la, shown is a typical terrestrial wireless communication network. Here, a plurality of wireless nodes 101 are fibre, wire or microwave connected to the internet 109 though router 105 and gateway 106 forming a wide area coverage network. Each node supports communication locally with other devices such as phones or CPEs.

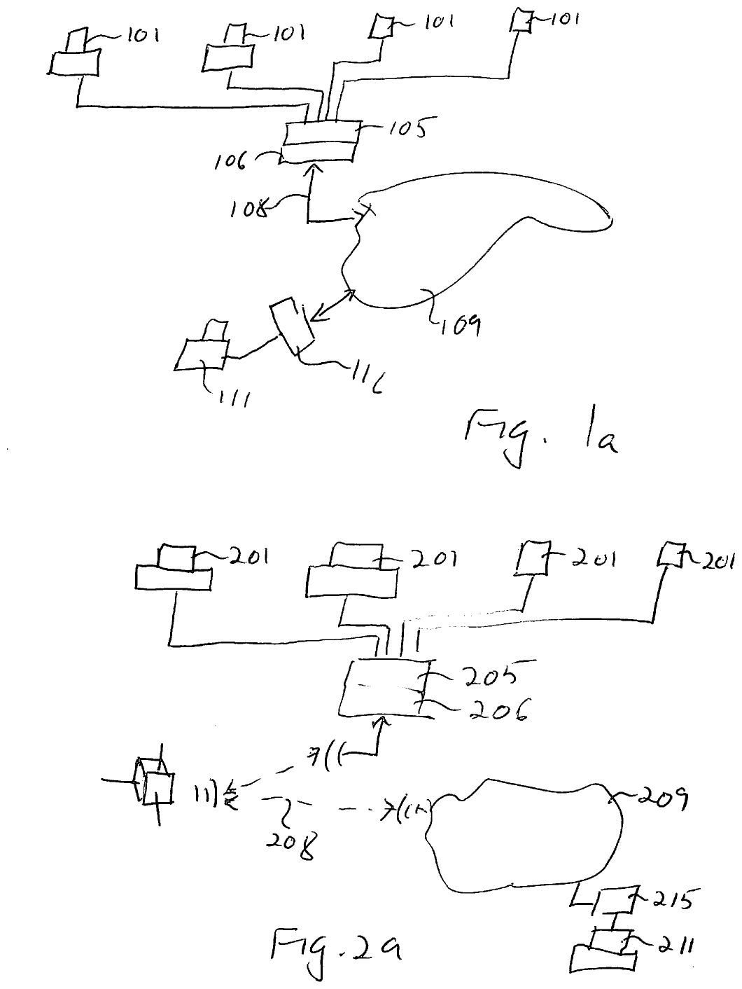

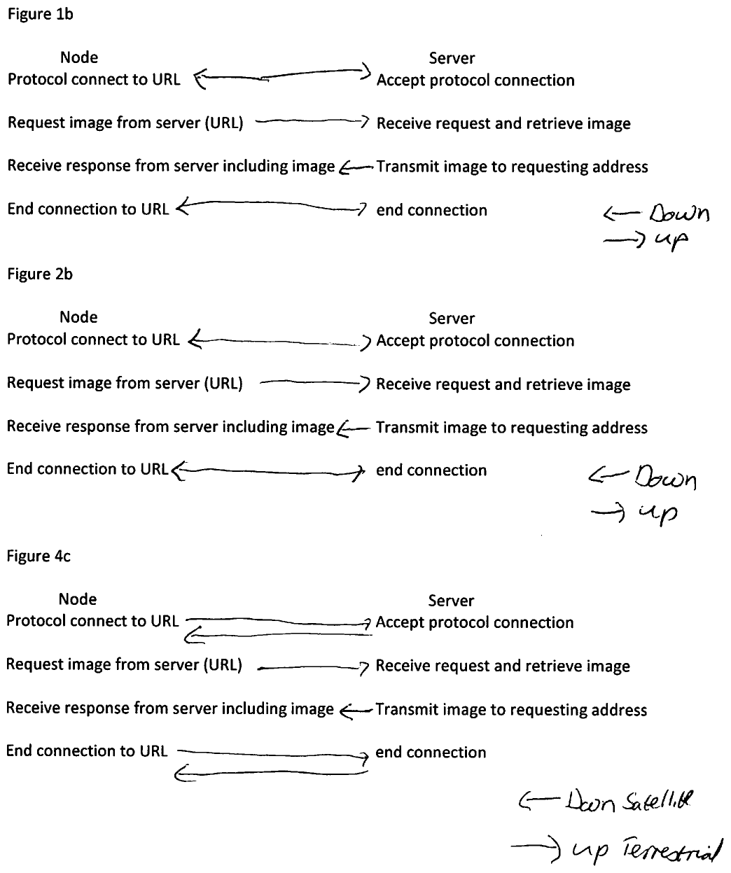

Referring to FIG. 1b, shown is a communication diagram for the system of Figure 1a. Here, a message is transmitted from a node 101 in the form of a user system to the local gateway 106 from which the message is routed via a terrestrial communication wide area network 109 to the server 111 disposed at a remote location. The server 111 receives the message, processes the message, and responds to the message via the terrestrial wide area network 109 to the local gateway 106 and then to the user system 101. As is evident, each message is transmitted from a system via a gateway through the wide area network to another gateway and to a destination system. That forms one way of a two-way communication exchange. The return message follows a similar but reverse path. Thus for each message pair, there are two paths each of which includes two separate connections to the wide area network.

Referring to FIG. 2a, shown is a typical satellite-based communication network. Here, a plurality of nodes 201 are wirelessly coupled to a local area network (LAN) via local area network router 205. A LAN gateway 206, forming part of the local area network router 205, is coupled to a wide area network in the form of the internet 209 via a high-speed satellite-based communication network connection 208. Each node supports communication locally with other nodes 201 via the wireless network router 205. The network provides communication to each wireless node so long as each node is operational and so long as communication to and from each node is uninterrupted. Via the Internet 209, each node 201 communicates with a large number of available servers 211 via gateways 215. Servers 211 often support access to data, services, and people via the satellite communication network connection 208.

Referring to FIG. 2b, shown is a communication diagram for the system of FIG. 2a. Here, a message is transmitted from a node 201 in the form of a user system to the local gateway 206 from which the message is routed via a terrestrial communication wide area network 209 to the server 211 disposed at a remote location. The server 211 receives the message, processes the message, and responds to the message via the terrestrial wide area network 209 to the local gateway 106 and then to the user system 201. As is evident, each message is transmitted from a system via a gateway through the wide area network to another gateway and to a destination system. That forms one way of a two-way communication exchange. The return message follows a similar but reverse path. Thus for each message pair, there are two paths each of which includes two separate connections—one uplink and one downlink—via the satellite communication link.

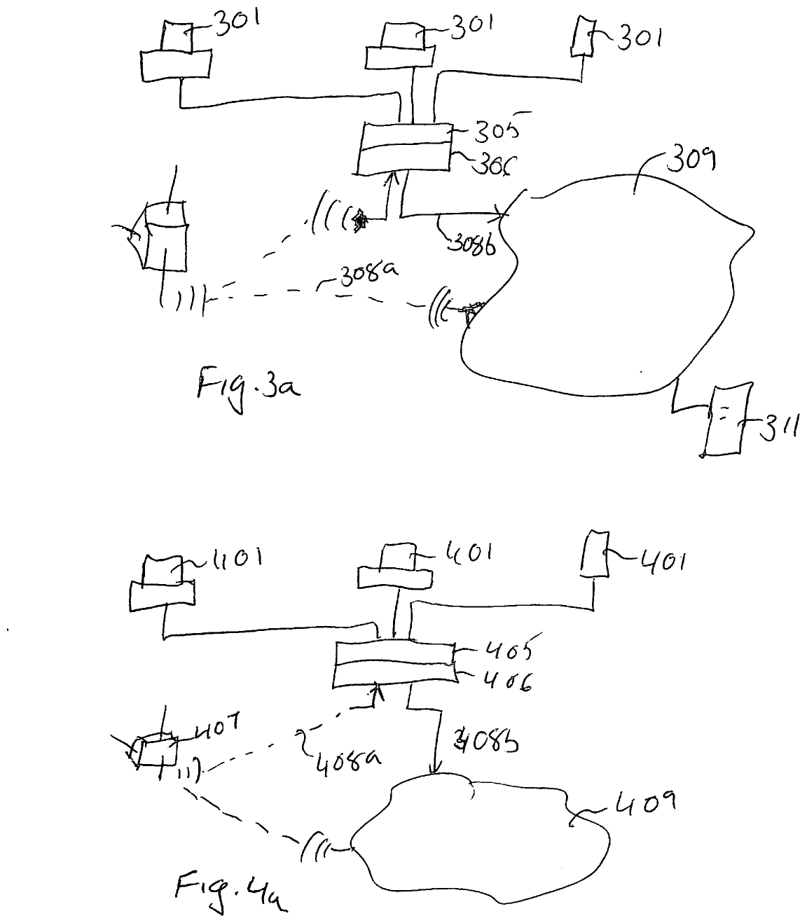

Referring to FIG. 3a, shown is a typical hybrid ground based and satellite-based communication network. Here, a plurality of nodes 301 are wirelessly coupled to a local area network (LAN) via local area network router 305. A LAN gateway 306 forming part of the local area network router 305 is coupled to a wide area network in the form of the internet 309 via a high-speed terrestrial wireless communication network 308b and via a high-speed satellite-based communication network 308a. In one implementation, the nodes 301 communicate via one of satellite communication network 308a and terrestrial wireless communication network 308b depending on what is available. Thus, communication data throughput and reliability are increased overall through load sharing of communication signals between the satellite communication network 308a and terrestrial wireless communication network 308b.

For example, reliability is increased because when one communication network fails, the other may remain available. In some implementations, terrestrial wireless communications network 308b is used for communication when available and satellite communication network 308a is used when terrestrial wireless communication network 308b is unavailable and satellite communication network 308a is available.

In another implementation, some nodes or parts of the wide area network are only accessible via satellite communication network 308a while others are accessible via terrestrial wireless communication network 308b. For example, servers and nodes in remote locations may only be connected to the wide area network via a satellite link. Conversely, in densely wooded areas, dense foliage may block satellite communication signals and therefore satellite communication, for example within the Ku band (12 GHz to 20 GHz) may be poorly suited to rooftop installations for some potential users.

In each implementation described above, nodes support communications locally with other nodes 301 via the wireless network router 305. The local area network provides communication to each wireless node so long as each node is operational and so long as communication to and from each node is uninterrupted. Via the Internet 309, each node 301 can also communicate with a large number of available servers 311, services, and people.

Assessing performance of each of the communication networks of FIGS. 1, 2, and 3a is complicated due to the numerous performance indicators such as data throughput, reliability, points of failure, latency, cost, availability, etc. For example, a very high data throughput network with a very long latency is useful for uploading file backups, background downloading of information, data propagation, etc. It is, however, not ideal for video conferencing or interactive online programs. Such a communication system is also poorly suited to supporting thin clients—clients relying on a server to do most of their processing operations and having limited local processing capacity—or real time systems. Conversely, a high-speed terrestrial wireless communication network provides low-latency and high-performance, but is poorly suited to very remote or isolated installations wherein the terrestrial wireless installation requires hundreds of miles of fibre and supporting hardware for a single home user. In rural areas, access to high-speed Internet connectivity has different considerations than in dense urban centers.

Further, data throughput availability becomes a problem not in hardware support, but in utilisation in denser areas where, for example, everyone piles onto the Internet when they return home from school resulting in high data throughput utilisation. Thus, examining and evaluating connectivity options is a complex task for balancing many different criteria.

To cover rural areas, a single wireless node should ideally transmit across more distance—cover more area—as there are fewer homes in a given geographical area. That said, to cover more area requires different protocols and frequency bands having excellent signal propagation, low path loss and a resilience to objects blocking signals within a communication path. Some protocols, such as TVWS communication, provide limited data throughput for a large geographical area covered. Others, such as WiFi provide very limited reach and therefore require a lot of infrastructure to cover a larger area. As regions get more remote, it becomes significantly advantageous to provide satellite communication which blankets large geographic areas without significant infrastructure or cabling and shares data throughput across those areas.

Unfortunately, switching from terrestrial wireless communication networks to satellite-based communication networks results in several drawbacks. First, a communication system having the power and directionality to communicate with a satellite is required. This can add cost and complexity to the overall system and its associated hardware. Additionally, a significant latency is added to a communication process because every messaging pair—request and response—travels up to the satellite twice and down from the satellite twice (not in that order). For some protocol handshakes, many message pairs are involved requiring dozens, or more, two-way messages via satellite. For many tasks, this is completely acceptable. A satellite's advantage lies in its supported downlink transmission data throughput and its ability to broadcast signals. For example, when transmitting 50 Mb, the latency of satellite communications is less problematic than the data throughput for transmitting 24 bytes. Satellite uplink is further limited and causes delays due to a long distance of signal propagation, signal collisions, and a feedback loop relied upon in the communication process. A satellite needs to receive signals from many different transceivers, user transceivers and ground stations coupled to the wide-area network, and to manage and maintain communications with each.

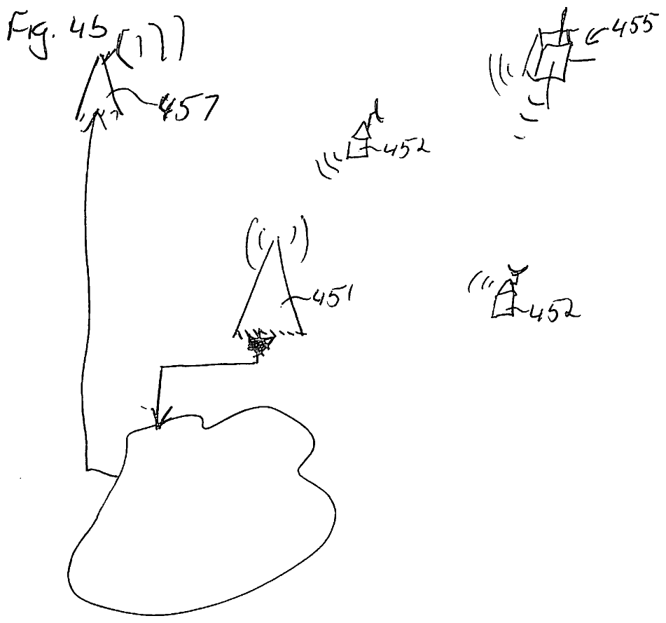

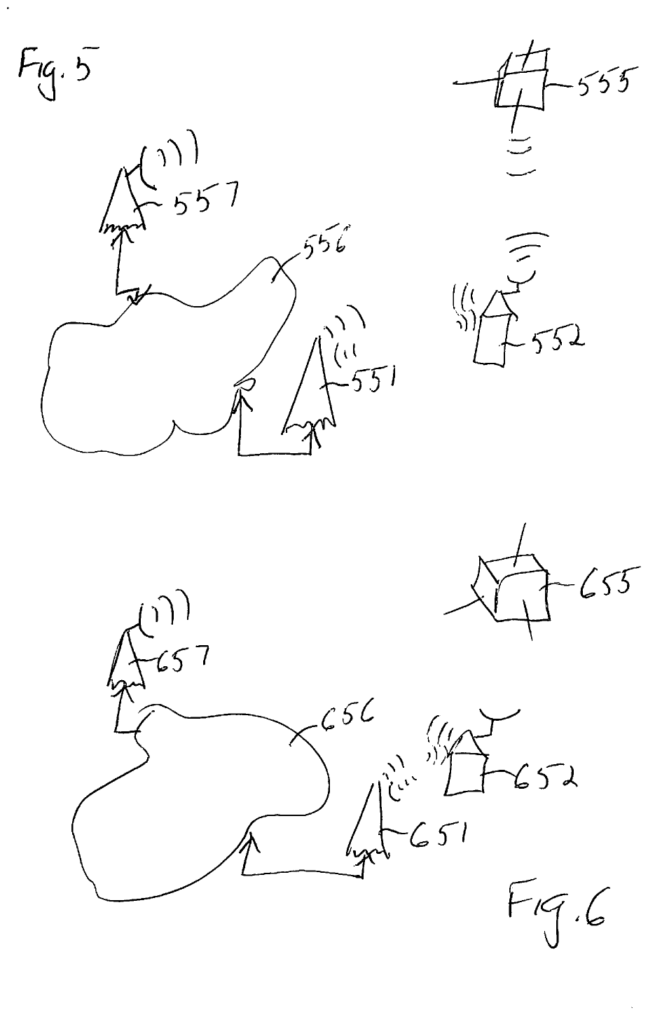

Referring to FIG. 4a, shown is a simplified diagram of a communication network wherein a satellite communication network's uplink is replaced with a terrestrial wireless communication network such that at least some nodes receive signals via a satellite communication link and respond via a terrestrial wireless communication network.

The resulting network has fewer interfering wireless uplink signals being transmitted up to each satellite. Further, the resulting network has lower latency—round-trip delay. The lower latency is a result of using satellite communication with higher latency in one direction and terrestrial communication with low latency in the other direction; when satellite latencies are much much larger than terrestrial communication latencies, the resulting system supports approximately half the latency of a bidirectional satellite communication path. When the terrestrial network has a lower latency than the satellite network, this still results in reduced latency.

Shown, a plurality of nodes 401 are wirelessly coupled to a local area network (LAN) via local area network router 405. A LAN gateway 406 forming part of the local area network router 405 is coupled for transmitting signals within a wide area network in the form of the internet 409 via a high-speed terrestrial wireless communication network 408b and for receiving signals from satellite 407 via a high-speed satellite-based communication network 408a. Each node supports communications locally with other nodes 401 via the wireless network router 405; for example, each node supports an 802.11 protocol for transmitting and receiving signals. The network provides communication to each wireless node so long as each node is operational and so long as communication to and from each node is available. Via the Internet 409, each node 401 communicates with a large number of available servers, services, and people.

A first system comprising a node of nodes 401 forms part of a loop transmitting signals along a first path, for example to a second other system, via a terrestrial network and receiving signals returned from the second other system via a satellite communication network. The resulting network has fewer wireless signals being transmitted to satellite 407, thereby reducing interference and collisions, with a theoretical possibility of no uplink transmissions to the satellite 407 from individual nodes 401; in such a theoretical architecture, only a ground station coupled to the Internet 409 provides a satellite uplink for responses received and directed to node 401. All signals from node 401 are transmitted via a terrestrial communication network. The communication path, has lower round-trip delay relative to a satellite only communication path. Potentially, the signal has a higher downlink data throughput than an available terrestrial wireless only communication path to node 401. A satellite-based/terrestrial wireless hybrid communication network supports a latency of satellite communications via the satellite from a server — a communication up to the satellite and back down to Earth—plus the latency of ground-based uplink signals from a node to the server via the terrestrial wireless communication network. Further, such a network greatly reduces data transmission along one direction — to the satellite from the nodes and to the nodes via the terrestrial network.

When an end user is in a remote location, providing installation of fixed-wire based or fibre based connectivity is often prohibitively expensive. That said, TVWS frequency bands support very large areas of coverage spanning long distances of significantly greater than 10 Km at moderate signal power levels. Unfortunately, as a density of a remote area increases, the limited data throughput supported by TVWS communication becomes a constraint. Though we typically imagine a remote individual being alone in a cabin miles away from anyone, more commonly remote individuals live in communities that are small and remote from other communities. If a TVWS communication setup is installed supporting a radius of 30 Km around a tower, this area (around 2700 square Km) might include many small towns or groups of houses. Supporting all of those homes peak communication needs might be difficult resulting in very low data throughput to each home during peak access times. Further, the transmitter within the TVWS tower transmits signals to cover the vast area while the homes from all sides transmit signals back to the TVWS tower; this may lead to considerable signal interference.

Referring to FIG. 4b, when a hybrid network is relied upon, the TVWS tower 451 receives signals from each connected device 452 within its supported radius. Those signals are passed onto the network from the TVWS tower, but return data signals are routed to the connected devices 452 via a satellite ground station 457 and satellite 455. The satellite 455 now transmits data signals to connected devices 452 but does not receive any. As such, the satellite 455 also has a simpler communication operating model—transmitting data received signals only arriving from a satellite ground station 457. In such a simplified embodiment, nodes—connected devices 452—need not be communicatively connected to ground based satellite transmitters—only satellite receivers are needed to receive satellite signals. Satellites are provided with response protocol and other signalling, such as confirmation signals, via the terrestrial communication network path but directed to a ground station to communicate to the satellite instead of being directly from consumer premise equipment to the satellite from a consumer premise equipment satellite link.

In another embodiment, some signals are communicated from the TVWS tower to the connected devices, for example for protocol or signal verification purposes while data content of signals is only received at the tower, passed to its destination and a return response is communicated via a satellite network.

In another embodiment, some signals are communicated from the connected devices directly to the satellite, for example for protocol or signal verification purposes while signals containing requested data content are transmitted from the satellite.

In another embodiment, some signals are communicated from the TVWS tower to the connected devices, for example for protocol or signal verification purposes while data content of signals is only received at the tower, and some signals are communicated from the connected devices to the satellite, for example for protocol or signal verification purposes while data content of signals is only transmitted from the satellite.

When hybrid network is relied upon, the TVWS tower receives data signals from each connected device within its supported radius. Those signals are passed onto the network from the TVWS tower, but return data signals are routed to the connected devices via a satellite communication system. Control signals can be restricted to a small fixed data throughput when they are implemented. Thus, the TVWS tower transceiver causes limited, if any, collisions in transmissions therefrom. The TVWS tower connects to the Internet via a ground based wired communication. Alternatively, the TVWS tower couples to the internet via a wireless communication such as point to point wireless communication or via a TVWS signal across 2 or more TVWS towers arranged in series for retransmitting data signals until they arrive at a TVWS tower that is connected to the WAN via another link. The satellite transmits data signals but does not receive data signals from the tower or connected devices. As such, the satellite also has a simpler communication operating model. Of course, as long as uplink requirements are significantly smaller that downlink requirements, such a setup supports sufficient data throughput for both up and down links. Even when uplink requirements are high, the setup supports enhanced overall data throughput relative to a satellite only or TVWS only implementation. In some embodiments, the satellite still receives some control and protocol signals from customer premise equipment. In some embodiments, the satellite still receives some signals from customer premise equipment, but fewer uplink signals than otherwise would be directed via the satellite.

Shown in FIG. 4c, signal paths for data exchanges are shown wherein all uplink communication is via terrestrial communication networks and all downlink communication is via satellite communication.

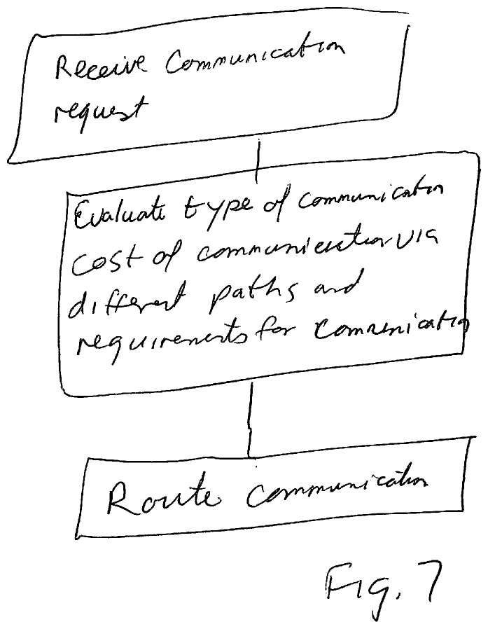

Referring to FIG. 5, in another embodiment, a satellite communication network's uplink portion is partially replaced with a terrestrial wireless TVWS communication network such that some nodes 552 receive signals via a satellite 555 communication and respond via a TVWS communication signal. The wide area network in the form of the Internet 556 connects to both the TVWS communication network and the satellite communication network. The TVWS tower 551 supports local wireless communication from nodes 552 across a long distance. The satellite 555 receives signals from the satellite ground station 557 and transmits them to nodes 552 and also receives some signals from the nodes 552 and transmits them to the ground station 557. This reduces the load on a satellites uplink and potentially reduces signal collisions. Further, such a network allows some nodes requiring higher uplink data throughput to access this data throughput in satellite communications while other nodes operate at lower latency. Relying on TVWS allows a large geographic area to be covered by a single transmitter and using that transmitter for communications in one direction reduces its load further. Even with the data throughput limitations that are present in some TVWS networks, because many uplink communications are much smaller than their downlink counterparts, a TVWS network used only for uplink would allow for considerable applications with lower latency and significant data throughput.

In one embodiment, each node is routed via the Internet 556 either through satellite, through terrestrial network, or through a terrestrial network uplink and a satellite network downlink. Alternatively, some short communication messages are routed via the terrestrial communication link. Alternatively, all short communication messages are routed via the terrestrial communication link.

In another embodiment, each data connection is evaluated for a type of communication. For example, a link to YouTube® which is generally for streaming video content relies on a satellite-communications for downlink and one of satellite and terrestrial based communication for uplink. When a request is for access to a different URL, for example a text-based search, then communication is routed via the terrestrial communication network. Thus, a local router can determine routing based on load balancing, data throughput requirements, and effects of latency on user experience. Optionally some communication routing is for protocol purposes or for supporting an underlying communication infrastructure and is routed accordingly.

Referring to FIG. 6, in another embodiment, a communication network's downlink portion is partially replaced with a terrestrial wireless TVWS wireless communication network such that some nodes receive signals via a TVWS communication signal and respond via the TVWS communication network. This reduces the load on a satellite's uplink and downlink for some nodes and potentially reduces signal collisions.

Node 652 communicates via uplink via TVWS tower 651 which passes the data onto the wide area network 656. Data returned to node 652 is transmitted via satellite ground station 657 to satellite 655 and then to node 652 via satellite communications. For smaller signals and for signaling requiring low latency, a TVWS downlink path is also available for communicating data to node 652.

Such a network architecture allows some nodes requiring higher data throughput to access this data throughput in satellite communications, while other nodes operate at much lower latency. Relying on TVWS allows a large geographic area to be covered by a single transmitter and using that transmitter for communications in one direction limits its load further. Even with the data throughput limitations that are present in some TVWS networks, this can be sufficient in many applications.

In another embodiment, a TVWS tower is equipped with a satellite transceiver and the TVWS tower communicates in one direction, for example uplink, via a ground-based communication network and in the other direction, for example downlink, via satellite communication. If a TVWS tower were coupled to the ground-based network via other TVWS towers, such a network topology would reduce latency while increasing overall data throughput, specifically when the other TVWS towers also serve customers wirelessly or other TVWS towers wirelessly within the TVWS communication network, thereby increasing load on a TVWS communication network.

Though the embodiments are described with reference to TVWS wireless communication, other terrestrial communication networks—fibre, wired or wireless—are also suitable for the architecture herein described.

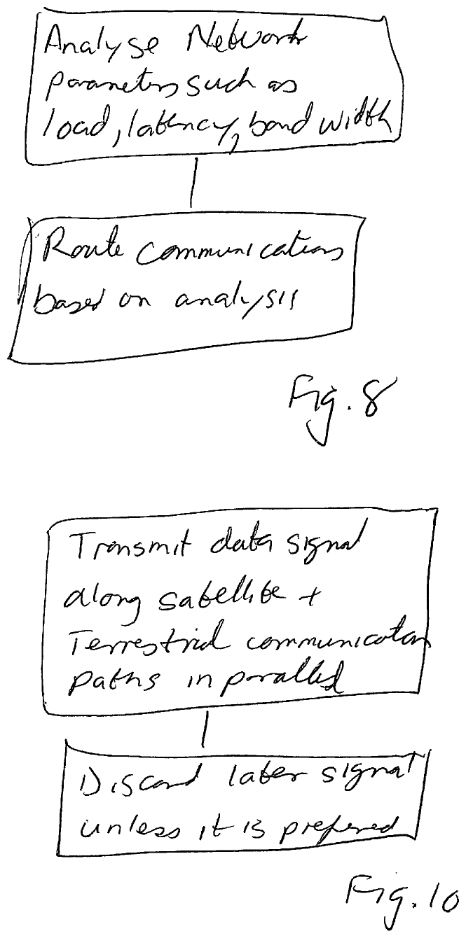

Referring to FIG. 7, in another embodiment, a node has both the ability to communicate bidirectionally via satellite and via a terrestrial wireless network and selection between available options—ground-based, satellite-based, or hybrid—is made based on at least one of a type of communication, available data throughput, and cost of a selection. This allows node connections to be based on usage, requirements, payment, or specific application. When based on specific application, a node is coupled to the network via a communication model that best supports all applications accessed by the node. Alternatively, for each application a separate network routing is used to optimise one of application performance and network resource utilisation.

When data throughput availability is a single criterion for selecting between communication options, data throughput availability is one of determined and estimated for each available communication network and for each direction. Based on data throughput requirements, an available option is selected. For example, for a communication requiring high data throughput upload and low data throughput download, available data throughput is less of a concern for download than for upload. The converse leads to the converse outcome. Thus, based on data throughput availability and data throughput requirements, an available option is selected.

In some applications, some nodes are fixedly set up to communicate with an uplink via a terrestrial wireless communication link and a downlink via a satellite-based communication link. In fact, these nodes are optionally not provided with a satellite transmitter.

Highly advantageously, should weather disrupt satellite communication entirely or nearly entirely, as long as the terrestrial wireless network communication hardware supports bidirectional communication, communication is routed via terrestrial wireless options exclusively until satellite communication data throughput is re-established.

Similarly, when hardware involved in network communication supports bidirectional communication, if data throughput utilisation is very low at 5 AM, then the terrestrial wireless communication network is used in both directions. At 8 AM when people wake up and begin to go onto the Internet, some communication or some users are routed via satellite to prevent congestion on the terrestrial wireless communication network. Now, this can be effected by routing different users differently, but also by routing users such that a substantially lower data throughput direction of communication is routed via a terrestrial wireless communication network.

In some embodiments, the entire terrestrial wireless network is switched to a single direction, uplink or downlink. In other embodiments some channels are switched to a single direction, uplink or downlink, to reduce interference.

Another measure for determining between available options is based on a communication type. Watching streaming video is routed with a downlink from satellite and an uplink via ground. Backing up data is routed with an uplink via satellite and a downlink via ground. Other communication types are also routed according to their typical communication patterns. Optionally, communication types and available data throughput are used one with another to determine between available options.

Another measure for determining between available options is based on a cost. A cost function is introduced for measuring cost. For example, cost is measured as a percentage of available data throughput such that unused network resources are nearly free and heavily used network resources are very expensive. In a cost model, each direction of communication is evaluated separately such that the uplink is communicated via a first option and the downlink via a second other option wherein each option is independently determined.

Watching streaming video is routed with a downlink with lowest cost supporting data throughput and throughput requirements for the video. Backing up data is costed independent of throughput but accounting for an amount of data to be transferred. Alternatively, data throughput is also evaluated for backing up data. Communication types are also routed according to their typical communication patterns as costs are evaluated based on projected communication patterns. Optionally, more than one of cost, communication types and available data throughput are used one with another to determine between available options.

Other potential variables used for evaluating options include priority of communication, security of communication, network conditions, connection reliability requirements, etc.

Further, a system designed to evaluate and select between available communication network options operates statically for a link such that once setup it remains in a selected option, operates dynamically such that it updates a selected option at intervals, is not fixed and allows some connections via one option and others via another simultaneously, or any mix of the above.

Using terrestrial wireless communication to replace satellite uplink is more practical and cost effective. This can significantly improve satellite communications for latency dependent applications and uplink centric applications such as IoT and precision farming, autonomous vehicles.

When all communications are fixedly communicated in an uplink direction via ground and a downlink direction via satellite, the satellite node hardware is simplified and need not transmit a signal through the atmosphere for thousands of kilometers. Further, a satellite network optionally supports both unidirectional receivers and bidirectional transceivers as the unidirectional receivers will simply reply via a terrestrial wireless communication network.

Providing an alternative uplink data path for satellite communication networks obviates some drawbacks of satellite communication such as latency, uplink capacity, and uplink support. Using TVWS to form a mesh network that covers areas of interest allows for a low cost, low latency large area network that supports a single communication direction—uplink. Further distributed terrestrial wireless network nodes are often cheaper and support higher levels of security that is upgradable.

In an embodiment, a wireless transceiver mimics a satellite receiver for the end user node such that the end user need not know that the uplink is routed via a terrestrial wireless network as a node supporting the end user or supporting a portion of a network supporting an end user modifies a signal to appear as if it traversed a same communication path via the satellite. Of course, this is not necessary when the server supports communication via different communication networks/paths.

By using one network to communicate in one direction, uplink/downlink frequency resources are saved for one direction, thereby improving overall data throughput and latency. This also reduces interference, a need to resend signals, signal collisions, etc.

One solution to the connectivity problem is to rely on satellite communication for providing additional data throughput and connectivity. Here, when a local network portion is heavily in demand such that data throughput becomes restricted, some data links—downlinks—are routed via a satellite communication network. For example, large file downloads can be served through a satellite downlink or, alternatively, started on a terrestrial wireless communication link and switched over to a satellite based downlink to limit noticeable latency. Offloading of local downlink data throughput through satellite communication is achievable with limited latency as the handover can occur at a point wherein a transition is not noticeable to an end user and can help local service providers during surge periods or when they outgrow their capacity and pending an upgrade to terrestrial wireless network hardware.

In such an application, a downlink via a ground-based network is established. The downlink is for downloading files or streaming data. A location within the data is selected for handover based on network characteristics and latency characteristics. The handover is selected at a location such that the ground-based network will reach approximately that location by the time the satellite communication begins to reach the end user node. Thus, the end-user will not notice the latency and the downlink data will be offloaded from the terrestrial wireless communication network.

Such an application is ideal for data at rest that is being downloaded or streamed. For example, for video conferencing, there is no way to transmit data before it is captured. That said, for downloading a large file, it is possible to download the first Megabyte via a terrestrial wireless network and at the same time start the second Megabyte via satellite such that the first byte of the second Megabyte arrives shortly after the first Megabyte has already arrived.

In another application, the method of hybrid wireless communication is used to support remote communities with more levels of service at different price points. Fort example, a satellite communication transceiver is coupled directly to a TVWS transceiver for receiving signals for local distribution while the TVWS transceiver is used for transmitting uplink signals via a terrestrial wireless communication network.

In some embodiments both the terrestrial wireless communication hardware and the satellite hardware are one-directional such that the only way to communicate is via a terrestrial wireless communication network uplink and a satellite-based downlink.

In some embodiments both the TVWS hardware and the satellite hardware are one-directional such that the only way to communicate is via a TVWS uplink and a satellite-based downlink.

Referring to FIG. 8, in another embodiment, a node has both the ability to communicate bidirectionally via satellite and via a terrestrial wireless network and selection between available options—ground-based, satellite-based, or hybrid—is made based on at least one of a type of communication, priority of communication, acceptable latency for communication, available data throughput, and cost of a selection. This allows node connections to be based on usage, requirements, payment, or specific application. In this embodiment, a cost analysis is made for communication routing either for each session or for each communication sequence. A communication is then routed according to the determination. Determinations regarding routing allow for load balancing, network optimisation, cost reduction, and most importantly for evaluating user experience to optimise same.

Though a flexible architecture uses bidirectional hardware at each gateway and can route communication messages in a variety of patterns. The flexible architecture can support higher data throughput and significant networking flexibility. Notably, the flexible architecture allows for evaluation of different objectives to optimise network communication for selected objectives be it latency, data throughput load, energy utilisation, etc. Further, when implemented as a backup communication network, such a system allows for backup communications that meet predetermined objectives. Further, such a backup network is adaptable to backup requirements.

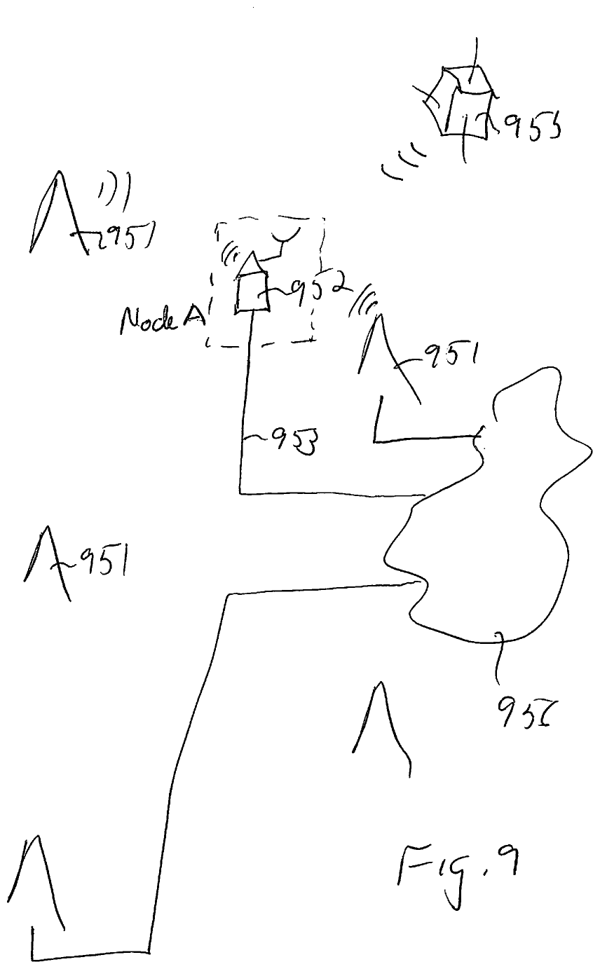

Referring to FIG. 9, shown is a broad TVWS communication backup network. The network spans hundreds of kilometers with towers 951 transmitting TVWS signals to provide wireless coverage. The TVWS coverage provides a communication network backup in case of terrestrial physical network 953 failure. Unfortunately, network failure is not predictable and where a network failure might occur is not known in advance. When the network fails at Node A, Node A communications are rerouted via the TVWS communication network. This is straightforward for rerouting a single node, but when network outages occur affecting many nodes, the TVWS communication network is loaded due to its limited data throughput and wide coverage area. In such a situation, providing a secondary backup satellite 555 supporting a downlink communication network or alternatively a bidirectional communication network allows for supporting high-data throughput network communications in accordance with embodiments of the invention.

Referring to FIG. 10, in another embodiment, when communication success and urgency exists, a signal is transmitted in both directions along both networks to ensure a greatest chance of successful reception. When the networking hardware supports such a configuration, it can be useful, for example when satellite communications is disrupted partially by weather such that signal arrival is not guaranteed. If, for example, a doctor was sending out important and urgent information and expecting a reply, such dual path communicating from a remote community—being very high priority as it is—might prove advantageous.

In some embodiments, the satellite downlink is selected preferentially for broadcast communications. In other embodiments, TVWS is used as a downlink for broadcast communications.

Numerous other embodiments may be envisaged without departing from the scope of the invention.

What is claimed is:

1. A method comprising:
initiating a communication link between a first system and a second other system, the communication link including an uplink from the first system to the second other system and a downlink from the second other system to the first system;
transmitting signals from the first system via the uplink consisting of a terrestrial wireless communication link absent satellite communications therein to the second other system; and
transmitting signals from the second other system via the downlink comprising a satellite-based communication link to the first system.

2. A method according to claim 1 wherein the downlink is transmitted via a communication link including portions that are ground-based.

3. A method according to claim 1 wherein the uplink from the first system to the second other system includes a link having low data throughput communication relative to the satellite communication data throughput.

4. A method according to claim 1 wherein for some first signals from the first system the uplink is via a terrestrial wireless network and for other second signals from the first system the uplink is via a satellite communication network.

5. A method according to claim 4 wherein the some first signals are determined based on data throughput utilisation of the terrestrial wireless network.

6. A method according to claim 4 wherein the some first signals are determined based on a type and purpose of the some first signals.

7. A method according to claim 4 wherein the some first signals are determined based on a latency requirement for the some first signals.

8. A method according to claim 1 wherein all signals from the first system transmitted via the uplink are transmitted via a terrestrial wireless network and all signals to the first system are via a satellite communication network.

9. A method according to claim 1 wherein the first system comprises a TVWS transceiver and a satellite receiver.

10. A method according to claim 9 wherein the first system is connected to a wide area network via a high-speed terrestrial connection and to customer premise equipment via TVWS wireless communication.

11. A method comprising:
initiating a communication link between a first customer system and a second other system;
determining a data throughput requirement for communicating from the first customer system to the second other system, available data throughput on each of a first terrestrial wireless communication link and a satellite communication link in each of an uplink and downlink direction; and
communicating with the second other system via a terrestrial wireless communication link absent satellite communications therein in either an uplink direction or a downlink direction; and
communicating with the second other system via a satellite communication link in another of the uplink direction or the downlink direction.

12. A system comprising:
an uplink transmitter configured to preferentially select a terrestrial wireless communication network for transmission of uplink signals;
a downlink receiver configured to receive signals transmitted thereto from a satellite directly;
and a local communication transceiver for transmitting signals to a local communications device and for receiving signals from a local communications device.

13. A system according to claim 12 wherein the local communication is via a frequency within the TVWS band.

14. A system according to claim 13 comprising a frame wherein the local communication transceiver is physically affixed to the frame and wherein the downlink receiver is also physically affixed to the frame.

15. A system according to claim 13 wherein the local communication transceiver is physically coupled to the downlink receiver with a communication cable.

16. The system of claim 12 wherein the uplink transmitter is absent a satellite transmitter for transmitting signals to a satellite.

17. The system of claim 12 wherein the system is configured for transmitting first signals via the uplink wireless transmitter and for receiving responses to the first signals via the downlink receiver.

18. The system of claim 12 wherein in use, signals are transmitted via the uplink transceiver exclusively via the terrestrial wireless communication network and received exclusively via the downlink receiver from the satellite.

19. The system of claim 12 wherein in use, signals are transmitted via the uplink transceiver exclusively via the terrestrial wireless communication network and some signals are received via the downlink receiver from the satellite and some signals are received via the downlink receiver via the terrestrial wireless communication network.
